(19) United States
(12) Patent Application Publication
(10) Pub. No.: US 2026/0244657 A1
(43) Pub. Date: Aug. 20, 2026

(54) MODEL-AGNOSTIC ORCHESTRATION FRAMEWORK FOR GENERATIVE ARTIFICIAL INTELLIGENCE

(71) Applicants: Elizabeth Reilley, Phoenix, AZ (US); Zohair Zaidi, Phoenix, AZ (US)

(72) Inventors: Elizabeth Reilley, Phoenix, AZ (US); Zohair Zaidi, Phoenix, AZ (US)

(73) Assignee: Arizona Board of Regents on Behalf of Arizona State University, Scottsdale, AZ (US)

(21) Appl. No.: 19/536,718

(22) Filed: Feb. 11, 2026

Related U.S. Application Data
(60) Provisional application No. 63/758,487, filed on Feb. 14, 2025.

(51) Int. Cl. G06F 16/3329; G06F 9/445; G06F 16/332; G06F 21/41; G06Q 10/0631

(52) U.S. Cl. CPC G06F 16/33295; G06F 9/44526; G06F 16/3322; G06F 21/41; G06Q 10/06316

(57) ABSTRACT

A system orchestrates generative artificial intelligence interactions by executing a model-agnostic integration framework that decouples user applications from distinct third-party large language models (LLMs). The system generates an AI builder interface to receive configuration settings for a custom AI agent, including a task profile and a safety protocol. Upon instantiating the agent, the system receives an input query and selects a target LLM based on a mapping between the task profile and capability metrics associated with the target LLM. The input query is routed to the selected target LLM via a centralized API layer to obtain a candidate response. Subsequently, the system executes a compliance verification engine to evaluate the candidate response against the safety protocol defined in the configuration settings. An evaluated response is generated based on this evaluation and output to the user, ensuring governance independent of the underlying model provider.

### CLAIM OF PRIORITY

This U.S. utility patent application claims the benefit of U.S. Provisional Patent Application No. 63/758,487, filed 14 February 2025, the entire contents of which is incorporated herein by reference.

### TECHNICAL FIELD

Aspects of the disclosure relate generally to computing systems and, more particularly, to information processing, distributed computing architectures, and software frameworks for integrating machine learning and artificial intelligence technologies across networked environments.

### BACKGROUND

Artificial intelligence and machine learning technologies, including generative artificial intelligence and large language models, have become increasingly integrated into computing environments for tasks such as natural language processing, content generation, data analysis, and automated decision support. Advances in model architectures, training techniques, and specialized hardware have enabled the development of large-scale models capable of performing complex operations across enterprise and consumer applications. Cloud-based infrastructure and application programming interfaces have further expanded access to these capabilities by allowing organizations to incorporate third-party models and services into existing software ecosystems.

At the same time, generative artificial intelligence capabilities are often provided by multiple vendors using differing interfaces, deployment requirements, and performance characteristics. Integrating these heterogeneous resources may involve custom connectors, model-specific configurations, and ongoing maintenance as providers update or replace their offerings. Variations in latency, cost, accuracy, and resource consumption across models can complicate selection and management decisions. In addition, organizational policies related to data governance, security, auditing, and responsible use may introduce additional considerations when routing information through external services or automating tasks across interconnected systems. As a result, managing interactions among applications, models, and external platforms can present operational and administrative complexity within distributed computing environments.

### SUMMARY

Techniques are described for coordinating interactions between user applications and multiple generative artificial intelligence models within a computing environment. In one example, a computing system includes processing circuitry and non-transitory computer-readable media storing instructions that configure the processing circuitry to execute a model-agnostic integration framework that decouples applications from a plurality of distinct third-party large language models. The system is configured to generate an interface through which a user provides configuration settings for a custom artificial intelligence agent, the settings defining a task profile and a safety protocol. Based on these settings, the system instantiates the custom agent within the integration framework, receives input queries directed to the agent, and selects a target model from among the plurality of models based on a mapping between the task profile and capability metrics associated with the target model. Queries are routed to the selected target model through a centralized application programming interface layer, and candidate responses are received for compliance evaluation.

Operations further include executing a compliance verification engine to evaluate the candidate responses against the defined safety protocol to generate evaluated responses for output. In various examples, the framework supports the modular substitution of models, the coordination of multiple agents, and the autonomous execution of workflows on external enterprise systems using an agentic framework. Additional operations may include augmenting queries with context from a vector database layer and calculating transaction-specific metrics such as privacy scores or environmental impact. These approaches may be implemented using software instructions stored on computer-readable media and executed by one or more processing devices within distributed or cloud-based computing architectures.

According to one example, a system for orchestrating generative artificial intelligence interactions, the system comprising processing circuitry. In one example, the system includes non-transitory computer-readable media comprising instructions that, when executed by the processing circuitry, configure the processing circuitry to execute a model-agnostic integration framework to decouple user applications from a plurality of distinct third-party large language models (LLMs). According to such examples, the system includes non-transitory computer-readable media comprising instructions that, when executed by the processing circuitry, configure the processing circuitry to generate, for display on a client device, an AI builder interface. In at least one example, the system includes non-transitory computer-readable media comprising instructions that, when executed by the processing circuitry, configure the processing circuitry to receive, via the AI builder interface, configuration settings for a custom AI agent, the configuration settings defining a task profile and a safety protocol. In some examples, the system includes non-transitory computer-readable media comprising instructions that, when executed by the processing circuitry, configure the processing circuitry to instantiate the custom AI agent within the model-agnostic integration framework. Further, the system includes non-transitory computer-readable media comprising instructions that, when executed by the processing circuitry, configure the processing circuitry to receive an input query directed to the custom AI agent. Additionally, the system includes non-transitory computer-readable media comprising instructions that, when executed by the processing circuitry, configure the processing circuitry to select a target LLM from the plurality of distinct third-party LLMs based on a mapping between the task profile and capability metrics associated with the target LLM. In other examples, the system includes non-transitory computer-readable media comprising instructions that, when executed by the processing circuitry, configure the processing circuitry to route the input query to the target LLM via a centralized API layer. Moreover, the system includes non-transitory computer-readable media comprising instructions that, when executed by the processing circuitry, configure the processing circuitry to receive a candidate response from the target LLM. Still further, the system includes non-transitory computer-readable media comprising instructions that, when executed by the processing circuitry, configure the processing circuitry to execute a compliance verification engine. In various examples, the system includes non-transitory computer-readable media comprising instructions that, when executed by the processing circuitry, configure the processing circuitry to evaluate, using the compliance verification engine, the candidate response against the safety protocol defined in the configuration settings and generate an evaluated response. Finally, the system includes non-transitory computer-readable media comprising instructions that, when executed by the processing circuitry, configure the processing circuitry to output the evaluated response.

According to another example, a method for orchestrating generative artificial intelligence interactions, the method comprising executing, by processing circuitry, a model-agnostic integration framework to decouple user applications from a plurality of distinct third-party large language models (LLMs). In one example, the method includes generating, for display on a client device, an AI builder interface. According to such examples, the method includes receiving, via the AI builder interface, configuration settings for a custom AI agent, the configuration settings defining a task profile and a safety protocol. In at least one example, the method includes instantiating the custom AI agent within the model-agnostic integration framework. In some examples, the method includes receiving an input query directed to the custom AI agent. Further, the method includes selecting a target LLM from the plurality of distinct third-party LLMs based on a mapping between the task profile and capability metrics associated with the target LLM. Additionally, the method includes routing the input query to the target LLM via a centralized API layer. In other examples, the method includes receiving a candidate response from the target LLM. Moreover, the method includes executing, by the processing circuitry, a compliance verification engine. Still further, the method includes evaluating, using the compliance verification engine, the candidate response against the safety protocol defined in the configuration settings to generate an evaluated response. Finally, the method includes outputting the evaluated response.

According to yet another example, a non-transitory computer-readable medium storing instructions that, when executed by processing circuitry, cause the processing circuitry to execute a model-agnostic integration framework to decouple user applications from a plurality of distinct third-party large language models (LLMs). In one example, the non-transitory computer-readable medium storing instructions causes the processing circuitry to generate, for display on a client device, an AI builder interface. According to such examples, the non-transitory computer-readable medium storing instructions causes the processing circuitry to receive, via the AI builder interface, configuration settings for a custom AI agent, the configuration settings defining a task profile and a safety protocol. In at least one example, the non-transitory computer-readable medium storing instructions causes the processing circuitry to instantiate the custom AI agent within the model-agnostic integration framework. In some examples, the non-transitory computer-readable medium storing instructions causes the processing circuitry to receive an input query directed to the custom AI agent. Further, the non-transitory computer-readable medium storing instructions causes the processing circuitry to select a target LLM from the plurality of distinct third-party large language models (LLMs) based on a mapping between the task profile and capability metrics associated with the target LLM. Additionally, the non-transitory computer-readable medium storing instructions causes the processing circuitry to route the input query to the target LLM via a centralized API layer. In other examples, the non-transitory computer-readable medium storing instructions causes the processing circuitry to receive a candidate response from the target LLM. Moreover, the non-transitory computer-readable medium storing instructions causes the processing circuitry to execute a compliance verification engine. Still further, the non-transitory computer-readable medium storing instructions causes the processing circuitry to evaluate, using the compliance verification engine, the candidate response against the safety protocol defined in the configuration settings and generate an evaluated response. Finally, the non-transitory computer-readable medium storing instructions causes the processing circuitry to output the evaluated response.

According to a particular example, there is a device which includes means for executing, by processing circuitry, a model-agnostic integration framework to decoupling user applications from a plurality of distinct third-party large language models (LLMs). In one example, the device includes means for generating, for display on a client device, an AI builder interface. According to such examples, the device includes means for receiving, via the AI builder interface, configuration settings for a custom AI agent, the configuration settings defining a task profile and a safety protocol. In at least one example, the device includes means for instantiating the custom AI agent within the model-agnostic integration framework. In some examples, the device includes means for receiving an input query directed to the custom AI agent. Further, the device includes means for selecting a target LLM from the plurality of distinct third-party large language models (LLMs) based on a mapping between the task profile and capability metrics associated with the target LLM. Additionally, the device includes means for routing the input query to the target LLM via a centralized API layer. In other examples, the device includes means for receiving a candidate response from the target LLM. Moreover, the device includes means for executing, by the processing circuitry, a compliance verification engine. Still further, the device includes means for evaluating, using the compliance verification engine, the candidate response against the safety protocol defined in the configuration settings to generate an evaluated response. Finally, the device includes means for outputting the evaluated response.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 illustrates a layered software architecture supporting orchestration of generative artificial intelligence interactions within a model-agnostic integration framework, in accordance with aspects of this disclosure.

FIG. 3 illustrates interactions between a model-agnostic integration framework and external services, in accordance with aspects of this disclosure.

FIG. 4 illustrates examples of task-specific agents and utilities instantiated by a model-agnostic integration framework, in accordance with aspects of this disclosure.

FIG. 5 is a flow diagram illustrating an example method for orchestrating generative artificial intelligence interactions, in accordance with aspects of this disclosure.

Like reference characters denote like elements throughout the text and figures.

### DETAILED DESCRIPTION

Techniques are described for coordinating interactions between user applications and multiple generative artificial intelligence models within a computing environment. In one example, a computing system includes processing circuitry and non-transitory computer-readable media storing instructions that configure the processing circuitry to execute a model-agnostic integration framework that decouples applications from a plurality of distinct third-party large language models. The system is configured to generate an interface through which a user provides configuration settings for a custom artificial intelligence agent, the settings defining a task profile and a safety protocol. Based on these settings, the system instantiates the custom agent within the integration framework, receives input queries directed to the agent, and selects a target model from among the plurality of models based on a mapping between the task profile and capability metrics associated with the target model. Queries are routed to the selected target model through a centralized application programming interface layer, and candidate responses are received for compliance evaluation.

Operations further include executing a compliance verification engine to evaluate the candidate responses against the defined safety protocol to generate evaluated responses for output. In various examples, the framework supports the modular substitution of models, the coordination of multiple agents, and the autonomous execution of workflows on external enterprise systems using an agentic framework. Additional operations may include augmenting queries with context from a vector database layer and calculating transaction-specific metrics such as privacy scores or environmental impact. These approaches may be implemented using software instructions stored on computer-readable media and executed by one or more processing devices within distributed or cloud-based computing architectures.

In various implementations, the described computing environment may be deployed as a shared or enterprise platform that provides access to artificial intelligence capabilities for users having different levels of technical expertise. The environment may include modular software components that support configuration of agents, integration of multiple model providers, and management of data resources through common interfaces. Such components may be arranged to operate within secured network boundaries or controlled execution contexts, for example sandboxed or tenant isolated environments, to facilitate testing, development, and operational use of artificial intelligence functionality.

Artificial intelligence technologies may evolve with changes in model architectures, provider offerings, and underlying compute infrastructure. Different providers may expose distinct application programming interfaces, pricing structures, and performance characteristics, including variations in latency, throughput, and resource consumption. As a result, computing platforms that incorporate these technologies may utilize plug-in or modular integration approaches that allow models, data stores, and policy or safety mechanisms to be added, replaced, or updated over time. These approaches may be implemented across cloud-based, on-premises, or hybrid infrastructures and may support coordination of interactions among applications, models, and external services within distributed computing systems.

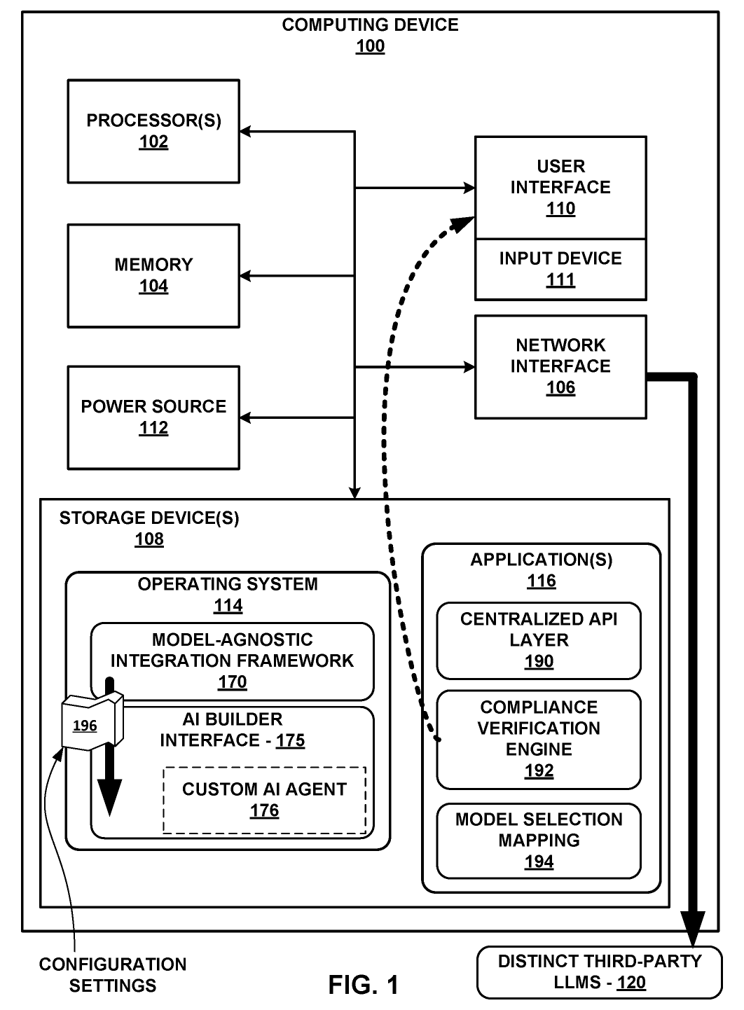

FIG. 1 is a block diagram illustrating further details of one example of computing device 100, in accordance with aspects of this disclosure.

Computing device 100 may include processor(s) 102, memory 104, network interface 106, storage device(s) 108, user interface 110, input device 111, and power source 112. Computing device 100 may correspond to any suitable computing system, such as a desktop computer, laptop computer, server, mainframe, cloud computing node, or mobile device. Processor(s) 102 may include one or more central processing units (CPUs), graphics processing units (GPUs), tensor processing units (TPUs), microcontrollers, digital signal processors (DSPs), or other processing circuitry configured to execute instructions. Processing circuitry may process instructions stored in memory 104 and instructions stored on storage device(s) 108.

Memory 104 may store information during operation of computing device 100 and may represent a computer-readable storage medium. Memory 104 may include volatile memory, meaning stored contents may not be maintained when computing device 100 is powered off, and non-volatile memory for longer-term retention. Examples of volatile memory may include random access memory (RAM), dynamic random access memory (DRAM), static random access memory (SRAM), cache memory, and similar technologies. Examples of non-volatile memory may include read-only memory (ROM), flash memory, electrically programmable read-only memory (EPROM), electrically erasable programmable read-only memory (EEPROM), and related technologies. Memory 104 may temporarily store program instructions and data for execution by processor(s) 102.

Storage device(s) 108 may include one or more non-transitory computer-readable storage media configured for persistent or long-term storage of information. Storage device(s) 108 may store larger quantities of data than memory 104. Examples of storage device(s) 108 may include magnetic hard disks, optical discs, floppy disks, solid-state drives (SSDs), flash arrays, or other non-volatile storage technologies.

Network interface 106 may enable communication with external systems and networks. Network interface 106 may include wired or wireless communication circuitry, such as Ethernet adapters, optical transceivers, radio frequency transceivers, cellular radios, or universal serial bus (USB) interfaces. Network interface 106 may support communication across local area networks, wide area networks, and cloud-based networks, and may exchange data with external computing resources including distinct third-party large language models (LLMs) 120.

User interface 110 may enable presentation of information to a user and receipt of user input. Input device 111 may include devices such as keyboards, pointing devices, touch-sensitive displays, microphones, cameras, or other sensors configured to detect user interactions through tactile, audio, visual, or electromagnetic input. User interface 110 may further include output devices configured to present information using visual, audio, or tactile output. Examples of output devices may include displays, speakers, video adapters, liquid crystal display (LCD) panels, cathode ray tube (CRT) monitors, or other presentation hardware. Power source 112 may supply electrical power to computing device 100 and may include rechargeable batteries, external power supplies, or connections to mains power.

Storage device(s) 108 may store operating system 114 and application(s) 116. Operating system 114 may manage hardware resources and coordinate execution of software components. Application(s) 116 may include executable instructions implementing artificial intelligence (AI) orchestration functionality. Model-agnostic integration framework 170 may execute within operating system 114 and may coordinate interactions between application(s) 116 and distinct third-party LLMs 120. AI builder interface 175 may receive configuration settings 196 defining task profiles, safety protocols, personas, or related parameters and may provide configuration information to custom AI agent 176. Custom AI agent 176 may receive input queries from user interface 110 or input device 111 and may provide requests to centralized application programming interface (API) layer 190.

Application(s) 116 may further include centralized API layer 190, compliance verification engine 192, and model selection mapping 194. Model selection mapping 194 may receive task profile information from custom AI agent 176 and may provide selection information identifying one of distinct third-party LLMs 120 based on associated capability metrics including historical performance data regarding latency, accuracy, and transaction-specific metrics such as financial cost or environmental carbon footprint scores (sometimes referred to as "Green AI" metrics). Centralized API layer 190 may receive routed queries from custom AI agent 176, may output the queries through network interface 106 to distinct third-party LLMs 120, and may receive candidate responses from distinct third-party LLMs 120. Compliance verification engine 192 (which may also be referred to herein as an "Ethical AI engine") may receive candidate responses from centralized API layer 190, may evaluate the candidate responses according to safety protocols defined by configuration settings 196, and may output evaluated responses to user interface 110 or to custom AI agent 176 for subsequent processing.

Through these interactions, model-agnostic integration framework 170, AI builder interface 175, custom AI agent 176, centralized API layer 190, compliance verification engine 192, model selection mapping 194, and distinct third-party LLMs 120 are configured to exchange data to process input queries and provide evaluated responses within computing device 100.

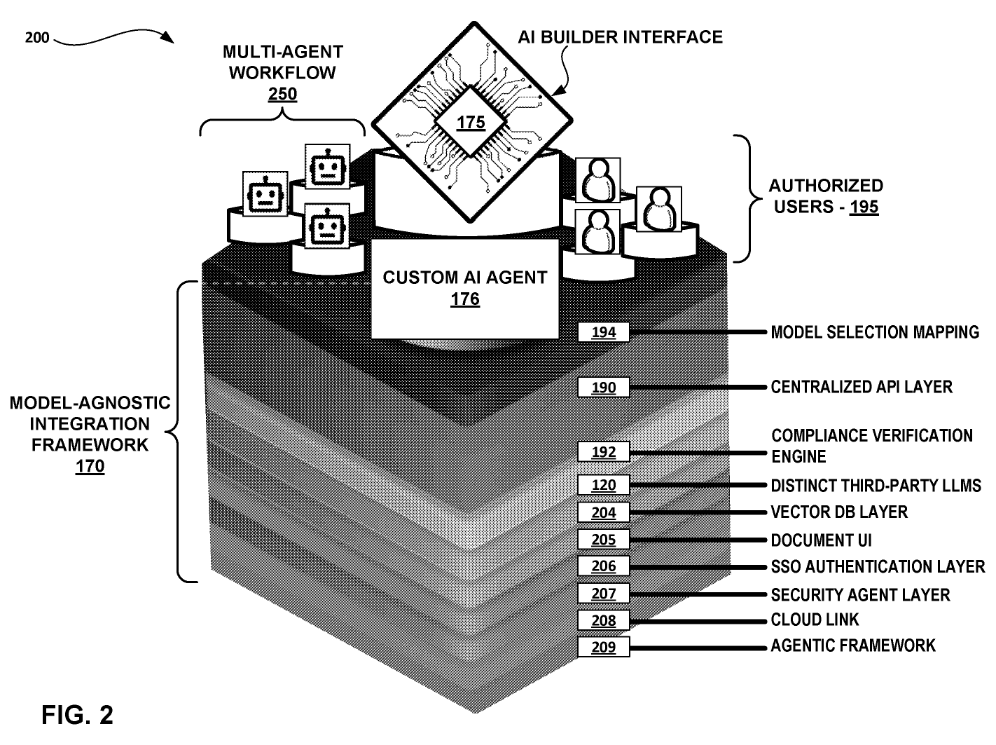

FIG. 2 illustrates a layered software architecture 200 supporting orchestration of generative artificial intelligence interactions within model-agnostic integration framework 170, in accordance with aspects of this disclosure.

Model-agnostic integration framework 170 may be organized as multiple logical layers that exchange data to configure agents, select models, route queries, evaluate responses, and interact with external resources. Model-agnostic integration framework 170 may be modular such that individual components may be added, removed, or replaced independently of other layers.

AI builder interface 175 may receive configuration input from authorized users 195 and may provide configuration data defining task profiles, safety protocols, prompts, or related parameters to custom AI agent 176. AI builder interface 175 may include graphical interfaces or programmatic interfaces through which agent behavior is specified. By providing a configuration-driven graphical environment, AI builder interface 175 democratizes the creation of artificial intelligence tools, enabling non-technical users to build and deploy custom AI agent 176 without prior coding knowledge. Subject matter experts, such as faculty or support staff, can leverage their domain expertise to craft tailored agents, defining personas, uploading knowledge from vector database layer 204, and setting safety rules, without relying on software engineering resources. This capability accelerates the adoption of AI across the enterprise by removing technical barriers to entry.

For example, AI builder interface 175 may accept a persona definition comprising a role, a tone, and a knowledge domain, and may automatically generate a system prompt configured to instruct the target model to adopt the persona during interaction. To facilitate discovery and collaboration, model-agnostic integration framework 170 may further include a community showcase layer accessible via user interface 110. This showcase layer functions as a central registry where authorized users 195 can publish, share, and trial beta versions of custom AI agent 176. Within this environment, users can explore a catalog of available agents, test capabilities using sample prompts, and provide feedback to the creators, thereby fostering a collaborative ecosystem for refining agent behaviors before broad enterprise deployment.

Custom AI agent 176 may receive input queries and may provide task information to model selection mapping 194. Model selection mapping 194 may associate task profiles, which may include parameters defining an input token length, a required reasoning complexity, and a domain specificity, with capability metrics including latency, cost, or accuracy and may output routing information to centralized API layer 190 using a weighted scoring algorithm that matches the parameters to the capability metrics.

Centralized API layer 190 may provide application programming interfaces that receive requests from custom AI agent 176 and output the requests to distinct third-party LLMs 120. Centralized API layer 190 may normalize message formats, manage authentication credentials, or aggregate responses across multiple model providers. Distinct third-party LLMs 120 may include externally hosted large language models configured to perform natural language processing tasks including text generation, summarization, translation, or analysis. Distinct third-party LLMs 120 may be integrated as interchangeable plug-in components.

Centralized API layer 190 may receive candidate responses from distinct third-party LLMs 120 and may provide the candidate responses to compliance verification engine 192. Compliance verification engine 192 may function as an ethical AI engine that evaluates candidate responses according to safety protocols, policy rules, or content criteria. Compliance verification engine 192 may perform operations including content classification, filtering, redaction, transformation, or hallucination detection and may output evaluated responses to custom AI agent 176 or AI builder interface 175.

Vector database (DB) layer 204 may store data as multi-dimensional vector representations to support similarity search and contextual retrieval. Vector database (DB) layer 204 may receive embeddings derived from documents or other data and may output retrieved context to custom AI agent 176 or centralized API layer 190. Document UI 205 may receive uploaded documents and may perform ingestion operations including parsing, segmentation, or embedding generation prior to storage within vector database (DB) layer 204.

SSO authentication layer 206, representing single sign-on authentication functionality, may receive authentication credentials and may provide unified access control across components of model-agnostic integration framework 170. Security agent layer 207 may receive requests exchanged among layers and may perform filtering, logging, auditing, encryption, or policy enforcement. Cloud link 208 may provide connectivity to remote or cloud-based compute resources and may route selected workloads to external processing environments. Furthermore, the centralized nature of model-agnostic integration framework 170 establishes a secure "garden wall" around institutional data. Unlike direct integrations where individual users or applications might transmit sensitive data directly to external endpoints, security agent layer 207 ensures that all interactions are intercepted, logged, and sanitized before leaving the secure network boundary. This architecture allows the organization to maintain strict data governance and audit trails, mitigating the risks associated with third-party data sharing while still enabling access to advanced generative capabilities.

Agentic framework 209 may receive evaluated responses or task directives and may initiate multi-step operations on external systems through application programming interfaces, thereby functioning as an autonomous orchestration layer. External systems may include learning management systems (LMS), customer support ticketing systems, student information systems, or enterprise resource planning (ERP) platforms. Agentic framework 209 may perform retrieval, update, or execution operations without direct user intervention to facilitate complex enterprise workflows.

Multi-agent workflow 250 may represent coordination among multiple instances of custom AI agent 176 operating sequentially or concurrently, where output from one agent may feed into additional agents to complete compound tasks.

Through these interactions, AI builder interface 175, authorized users 195, custom AI agent 176, model selection mapping 194, centralized API layer 190, compliance verification engine 192, distinct third-party LLMs 120, vector DB layer 204, document UI 205, SSO authentication layer 206, security agent layer 207, cloud link 208, agentic framework 209, and multi-agent workflow 250 are configured to exchange data to process requests and responses within model-agnostic integration framework 170.

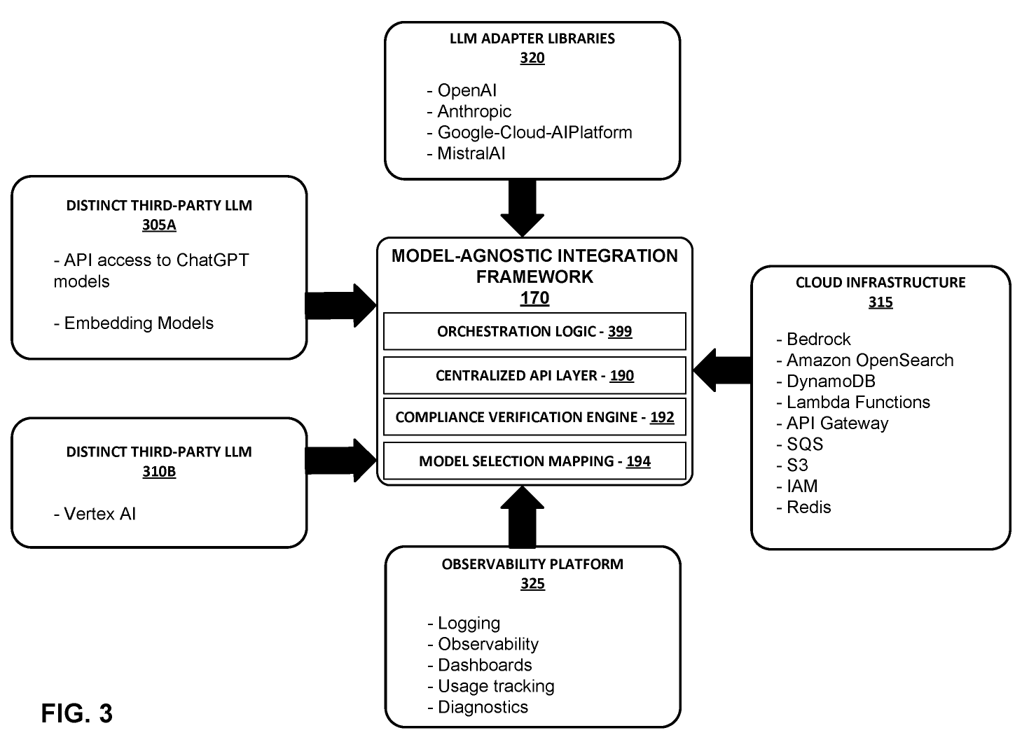

FIG. 3 illustrates interactions between model-agnostic integration framework 170 and external services, in accordance with aspects of this disclosure.

Model-agnostic integration framework 170 may operate as an implementation environment that integrates external ecosystem components with internal orchestration functions. Model-agnostic integration framework 170 may encapsulate orchestration logic 399 as an internal code base, for example a Python-based infrastructure, that manages request assembly, routing control, credential handling, policy context propagation, and transaction state management. Orchestration logic 399 may coordinate interactions among internal engines and external providers while decoupling control functions from provider-specific interfaces to support interoperability across heterogeneous providers.

Model-agnostic integration framework 170 may further include centralized API layer 190, compliance verification engine 192, and model selection mapping 194. Centralized API layer 190 may receive requests generated by upstream components described in FIGS. 1–2 and may output provider-compatible requests to external services. Centralized API layer 190 may normalize request and response formats, manage authentication credentials, enforce rate limits, and aggregate responses across multiple providers. Model selection mapping 194 may receive task profiles, may evaluate capability metrics, and may output selection information identifying a target model for a given request. Capability metrics may include latency, throughput, cost, or accuracy, including historical performance data gathered over prior transactions. Compliance verification engine 192 may receive candidate responses returned by external services and may output evaluated responses after applying safety protocols, policy rules, or content criteria.

Compliance verification engine 192 may perform operations including content classification, filtering, redaction, transformation, and hallucination detection, with evaluation rules applied independently of provider identity. In some implementations, compliance verification engine 192 evaluates candidate responses according to a multi-dimensional framework comprising specific metrics for accuracy, calibration, robustness, fairness, bias, toxicity, and efficiency. Accuracy may refer to an exact-match accuracy metric in text classification scenarios, while calibration measures the ability of a target model to express uncertainty so that errors are anticipated. Robustness is evaluated by measuring performance variations across different transformations of the same input query. Fairness assesses counterfactual fairness or performance disparities across different demographic groups, and bias detection identifies systematic asymmetries in language choice. Toxicity scanning screens for hate speech, violent speech, and abusive language. Furthermore, efficiency metrics track energy consumption, carbon footprint, and wall-clock time for both training and inference operations to provide a holistic view of model performance. For example, the system may calculate a transaction-specific carbon footprint score by multiplying an estimated energy consumption value, derived from a parameter count of the target model and an inference duration, by a real-time grid carbon intensity factor associated with a geographic region of a data center hosting the target model. Additionally, the system may generate a privacy impact score by detecting a density of personally identifiable information (PII) within the input query and weighting the density based on a data retention policy and a legal jurisdiction associated with the target model.

LLM adapter libraries 320 may support interoperability between model-agnostic integration framework 170 and heterogeneous provider interfaces. LLM adapter libraries 320 may include software development kits or packages that abstract connection details, authentication methods, request formats, response schemas, and error handling for multiple providers. In some examples, LLM adapter libraries 320 may support interaction with large language models (LLMs) provided through OpenAI application programming interfaces, Anthropic model endpoints, Google Cloud AI Platform services including Vertex AI, and MistralAI model endpoints. To achieve this connectivity, LLM adapter libraries 320 may incorporate specific Python-based software development kits and packages corresponding to the supported providers. For example, the system may utilize the OpenAI library for GPT-based models, the anthropic library for Claude models, the google-cloud-aiplatform library for Vertex AI integration, and the MistralAI library for connecting to Mistral endpoints. These libraries abstract the low-level HTTP request structures, allowing centralized API layer 190 to interact with diverse backends using standardized function calls.

Use of LLM adapter libraries 320 may allow centralized API layer 190 and orchestration logic 399 to invoke normalized interfaces while permitting providers to be added, removed, or replaced without modification of higher-level control logic. This modular architecture provides significant advantages regarding operational continuity and vendor independence. By decoupling the application layer from the specific implementation details of distinct third-party LLMs 120, model-agnostic integration framework 170 effectively "future-proofs" the enterprise environment against rapid changes in the artificial intelligence market. For instance, if a specific provider changes its pricing model, deprecates a model version, or suffers an outage, administrators can reconfigure LLM adapter libraries 320 or model selection mapping 194 to route traffic to an alternative provider without requiring code refactoring within application(s) 116. This prevents vendor lock-in and allows the organization to leverage the most cost-effective or capable models available at any given time.

Model-agnostic integration framework 170 may connect to multiple external model services represented by distinct third-party LLM 305A and distinct third-party LLM 310B. Distinct third-party LLM 305A may provide application programming interface access to conversational models and embedding models. Embedding models may generate vector representations that support similarity search, semantic retrieval, and contextual augmentation workflows described in FIG. 2. Distinct third-party LLM 310B may provide managed services supporting training, deployment, and monitoring of artificial intelligence models, including pre-trained or custom-trained models. Centralized API layer 190 may output requests to distinct third-party LLM 305A and distinct third-party LLM 310B using provider-specific authentication credentials, and model selection mapping 194 may select between distinct third-party LLM 305A and distinct third-party LLM 310B based on capability metrics associated with task profile requirements.

Cloud infrastructure 315 may provide supporting compute and storage services used by model-agnostic integration framework 170. Cloud infrastructure 315 may include foundation model access services such as Amazon Bedrock, search and indexing services supporting vector search and full-text search such as Amazon OpenSearch, low-latency NoSQL storage such as DynamoDB, and serverless compute resources for event-driven execution including Lambda Functions. Cloud infrastructure 315 may further include managed endpoint services such as API Gateway, message queues for asynchronous processing such as Amazon SQS, object storage for datasets and artifacts such as Amazon S3, identity management for access control such as IAM, and in-memory data stores for caching and real-time analytics such as Redis.

To support these services, cloud infrastructure 315 may utilize a stack of specific component technologies. For example, cloud infrastructure 315 may implement serverless computing using AWS Lambda Functions and manage API traffic through an API Gateway. Data persistence and retrieval may be handled by Amazon DynamoDB for NoSQL needs and Amazon S3 for object storage, while search capabilities are provided by Amazon OpenSearch. Asynchronous message queuing may be facilitated by Amazon Simple Queue Service (SQS), with caching and session management provided by Redis. Identity and access management (IAM) protocols facilitate secure control over these resources. Additionally, the system may integrate foundation model access through services such as Amazon Bedrock to connect with distinct third-party LLMs 120.Centralized API layer 190 may output requests to cloud infrastructure 315 for supporting operations including storage of artifacts, persistence of transaction records, queueing of workflow steps, or invocation of compute functions.

Observability platform 325 may support monitoring, diagnostics, and operational reporting for transactions processed by model-agnostic integration framework 170. Observability platform 325 may receive telemetry outputs including logs, traces, metrics, and event records from orchestration logic 399, centralized API layer 190, compliance verification engine 192, and model selection mapping 194. Observability platform 325 may provide logging, observability, dashboards, usage tracking, and diagnostics to monitor latency, cost, and error rates across interactions with distinct third-party LLM 305A, distinct third-party LLM 310B, and cloud infrastructure 315. In a specific implementation, observability platform 325 utilizes industry-standard monitoring tools, such as Datadog, to provide real-time visibility into the performance of model-agnostic integration framework 170. This configuration enables the generation of granular observability dashboards that track usage spikes, debug latency issues within large language model chains, and correlate error rates with specific distinct third-party LLMs 120, ensuring enterprise-grade reliability and operational transparency. This transparency enables users and administrators to make informed decisions that align with organizational values, such as sustainability and financial responsibility. By presenting transaction-specific metrics, such as the estimated carbon footprint or financial cost of a query, observability platform 325 empowers users to select distinct third-party LLMs 120 that offer a lower environmental impact or better cost efficiency for a given task. This promotes a culture of responsible innovation, where the consumption of computational resources is balanced against the value of the generated output.

In operation, model-agnostic integration framework 170 may receive requests from upstream components and may feed requests into orchestration logic 399. Orchestration logic 399 may provide routing context to model selection mapping 194 and centralized API layer 190. Model selection mapping 194 may output selection information identifying one of distinct third-party LLM 305A or distinct third-party LLM 310B. Centralized API layer 190 may output requests through interfaces supported by LLM adapter libraries 320 and may receive candidate responses. Centralized API layer 190 may feed candidate responses into compliance verification engine 192, and compliance verification engine 192 may output evaluated responses for downstream processing. Observability platform 325 may receive telemetry during processing to support auditing, monitoring, and operational maintenance.

Modularity of model-agnostic integration framework 170 may enable compatibility with multiple external services while preserving consistent routing, governance, and compliance behavior across provider interactions.

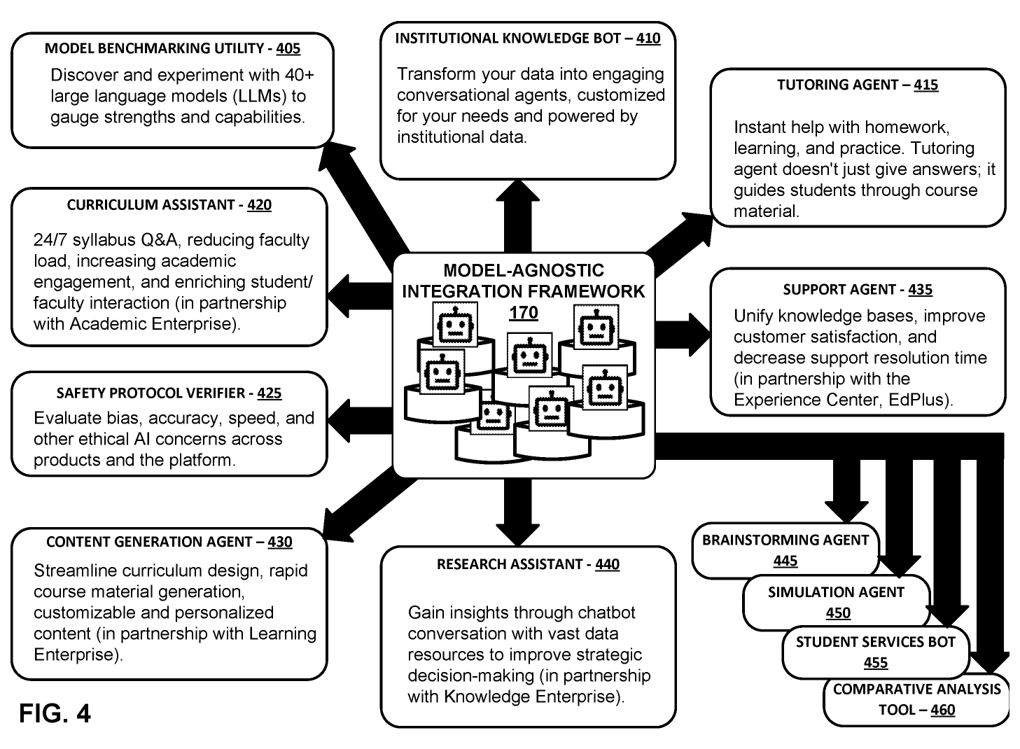

FIG. 4 illustrates examples of task-specific agents and utilities instantiated by model-agnostic integration framework 170, in accordance with aspects of this disclosure.

Model-agnostic integration framework 170 may operate as an execution environment configured to instantiate multiple configurable software agents, each corresponding to a defined task profile and capability requirement. Each agent may be created using configuration settings received through AI builder interface 175 described with respect to FIGS. 1–2 and may utilize orchestration logic 399, centralized API layer 190, compliance verification engine 192, and model selection mapping 194 described with respect to FIG. 3 to access external large language models (LLMs), apply governance controls, and output evaluated responses. Model-agnostic integration framework 170 may thereby provide a modular catalog of domain-specific agents without requiring modification of underlying routing or compliance mechanisms.

Model benchmarking utility 405 may enable users, administrators, or both to discover and experiment with multiple LLMs to gauge strengths and capabilities. Model benchmarking utility 405 may receive test prompts, feed requests into centralized API layer 190, and output comparative performance information including latency, throughput, cost, and accuracy metrics. Model benchmarking utility 405 may further support benchmarking of resource consumption or other operational characteristics to inform model selection decisions.

Institutional knowledge bot 410 may transform organizational or institutional datasets into conversational agents customized for specific operational needs. Institutional knowledge bot 410 may receive internal documents, policies, or knowledge bases, generate embeddings or contextual indices, and output responses reflecting institution-specific terminology and procedures. In some examples, institutional knowledge bot 410 incorporates adaptive learning algorithms to refine responses based on user interactions and may thereby provide domain-aware assistance using proprietary or locally stored data sources.

Tutoring agent 415 may provide interactive assistance for homework, learning, and practice activities. Tutoring agent 415 may receive learner questions, feed requests into model-agnostic integration framework 170, and output guided explanations or stepwise assistance instead of outputting direct answers. Tutoring agent 415 may adapt responses based on prior interactions or detected proficiency levels to support progressive learning outcomes.

Curriculum assistant 420 may provide syllabus-related question and answer functionality on a continuous basis to reduce faculty workload and increase academic engagement. Curriculum assistant 420 may receive course schedules, policies, or instructional materials and may output contextually relevant answers to student or instructor inquiries. Curriculum assistant 420 may integrate with institutional data stores to maintain current course information.

Safety protocol verifier 425 may evaluate artificial intelligence outputs for bias, accuracy, speed, and other ethical or compliance considerations. Safety protocol verifier 425 may receive candidate responses generated by external models and may apply filtering, classification, or rule-based validation prior to output. Safety protocol verifier 425 may operate in coordination with compliance verification engine 192 to apply defined safety protocols across multiple agents and workflows.

Content generation agent 430 may streamline curriculum design or other document creation tasks by rapidly generating draft materials. Content generation agent 430 may receive prompts or templates and may output customizable and personalized content suitable for instructional or informational use. Content generation agent 430 may support iterative refinement by receiving feedback and regenerating updated content.

Support agent 435 may unify knowledge bases to improve customer satisfaction and decrease support resolution time. Support agent 435 may receive service requests, retrieve relevant articles or prior cases, and output recommended actions or automated responses. Support agent 435 may integrate predictive analytics and may interface with ticketing or customer relationship systems to assist with workflow automation.

Research assistant 440 may facilitate analysis and decision support through conversational access to large datasets or research repositories. Research assistant 440 may receive queries, retrieve structured or unstructured information, and output synthesized summaries or insights to assist strategic planning. Research assistant 440 may support exploration of multiple scenarios or scenario-based simulations to evaluate potential outcomes.

Brainstorming agent 445 may support ideation and exploratory workflows. Brainstorming agent 445 may receive high-level concepts and output alternative approaches, suggestions, or creative variations. Brainstorming agent 445 may include gamified exercises to inspire divergent thinking and may be utilized in educational or enterprise environments to promote solution discovery.

Simulation agent 450 may integrate generative artificial intelligence outputs with simulation or virtual environments, including virtual reality (VR) environments. Simulation agent 450 may receive scenario parameters and output simulated behaviors, generated content, or adaptive interactions within interactive systems to support training, experimentation, or experiential learning use cases. In a specific deployment example, simulation agent 450 may be configured with a distinct persona, such as that of a university president or subject matter expert, to engage users in a critical thinking exercise or "battle of wits." In this scenario, simulation agent 450 adopts the specific tone, rhetorical style, and knowledge base associated with the persona to challenge user arguments and reinforce learning objectives. This enables the creation of immersive educational experiences where students or faculty can debate complex topics with an AI counterpart calibrated to mimic specific intellectual or leadership styles.

Student services bot 455 may assist with administrative or campus-related services. Student services bot 455 may receive requests related to scheduling, enrollment, or resource navigation and may output procedural guidance or automated task execution. Student services bot 455 may interface with institutional systems to retrieve or update records as permitted by access controls.

Comparative analysis tool 460 may enable side by side evaluation of outputs from multiple models or agents. Comparative analysis tool 460 may receive identical prompts, feed requests into multiple providers through centralized API layer 190, and output comparative results to facilitate empirical selection of a preferred model or configuration. Comparative analysis tool 460 may present performance statistics or qualitative assessments to assist administrators in optimization decisions. Additionally, comparative analysis tool 460 may utilize the comparative results to automatically recalibrate routing logic within model selection mapping 194 to bypass a target model exhibiting high latency or error rates, thereby improving technical reliability and reducing resource contention within the computing system.

Through these interactions, model benchmarking utility 405, institutional knowledge bot 410, tutoring agent 415, curriculum assistant 420, safety protocol verifier 425, content generation agent 430, support agent 435, research assistant 440, brainstorming agent 445, simulation agent 450, student services bot 455, and comparative analysis tool 460 may each receive input from and output to model-agnostic integration framework 170, thereby enabling task-specific artificial intelligence functionality while preserving shared orchestration, routing, and compliance behavior across model-agnostic integration framework 170.

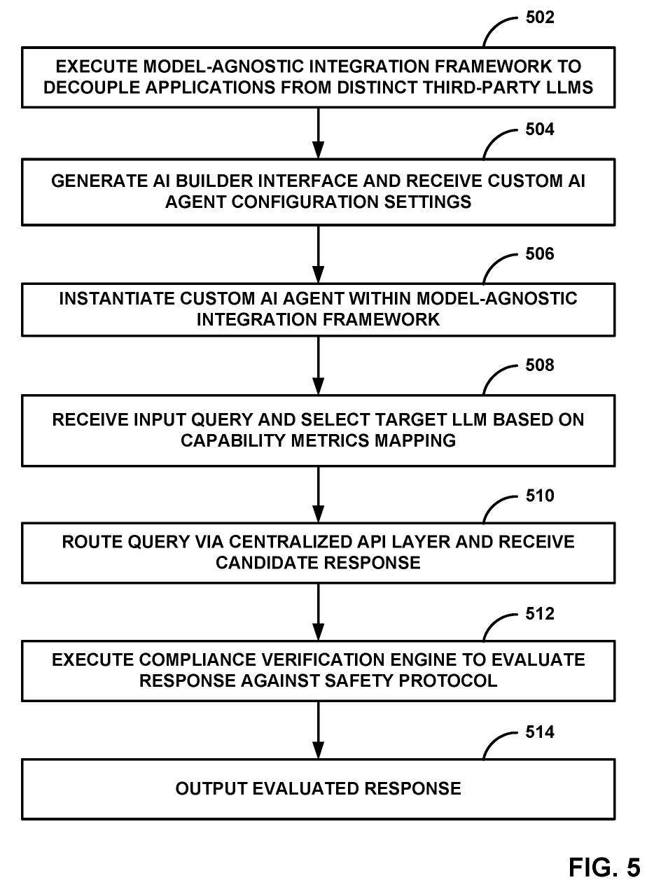

FIG. 5 is a flow diagram illustrating an example method for orchestrating generative artificial intelligence interactions, in accordance with aspects of this disclosure. FIG. 5 is described with respect to computing device 100, model-agnostic integration framework 170, and related components shown in FIGS. 1-4. However, the techniques of FIG. 5 may be performed by different or alternative systems.

Processing circuitry of computing device 100 may be configured to execute a model-agnostic integration framework to decouple applications from distinct third-party LLMs (502). For example, processing circuitry may be configured to execute, by processing circuitry, a model-agnostic integration framework to decouple user applications from a plurality of distinct third-party large language models (LLMs).

Processing circuitry of computing device 100 may be configured to generate an AI builder interface and receive custom AI agent configuration settings (504). For example, processing circuitry may be configured to generate, for display on a client device, an AI builder interface, and receive, via the AI builder interface, configuration settings for a custom AI agent, the configuration settings defining a task profile and a safety protocol.

Processing circuitry of computing device 100 may be configured to instantiate a custom AI agent within the model-agnostic integration framework (506). For example, processing circuitry may be configured to instantiate the custom AI agent within the model-agnostic integration framework.

Processing circuitry of computing device 100 may be configured to receive input query and select target LLM based on capability metrics mapping (508). For example, processing circuitry may be configured to receive an input query directed to the custom AI agent, and select a target LLM from the plurality of distinct third-party LLMs based on a mapping between the task profile and capability metrics associated with the target LLM.

Processing circuitry of computing device 100 may be configured to route query via centralized API layer and receive candidate response (510). For example, processing circuitry may be configured to route the input query to the target LLM via a centralized API layer, and receive a candidate response from the target LLM.

Processing circuitry of computing device 100 may be configured to execute a compliance verification engine to evaluate response against a safety protocol (512). For example, processing circuitry may be configured to execute, by the processing circuitry, a compliance verification engine, and evaluate, using the compliance verification engine, the candidate response against the safety protocol defined in the configuration settings to generate an evaluated response.

Processing circuitry of computing device 100 may be configured to output evaluated response (514). For example, processing circuitry may be configured to output the evaluated response.

In this way, FIG. 5 illustrates a method for systematically orchestrating interactions between custom agents and heterogeneous external models, facilitating model selection driven by task requirements while safety protocols are enforced uniformly across all outputs.

Examples of the various aspects of this disclosure may be used individually or in any combination. Additional aspects of the disclosure are detailed in numbered clauses below.

Clause 1 - A system for orchestrating generative artificial intelligence interactions, the system comprising: processing circuitry; and non-transitory computer-readable media comprising instructions that, when executed by the processing circuitry, configure the processing circuitry to: execute a model-agnostic integration framework to decouple user applications from a plurality of distinct third-party large language models (LLMs); generate, for display on a client device, an AI builder interface; receive, via the AI builder interface, configuration settings for a custom AI agent, the configuration settings defining a task profile and a safety protocol; instantiate the custom AI agent within the model-agnostic integration framework; receive an input query directed to the custom AI agent; select a target LLM from the plurality of distinct third-party large language models (LLMs) based on a mapping between the task profile and capability metrics associated with the target LLM; route the input query to the target LLM via a centralized API layer; receive a candidate response from the target LLM; execute a compliance verification engine; evaluate, using the compliance verification engine, the candidate response against the safety protocol defined in the configuration settings and generate an evaluated response; and output the evaluated response.

Clause 2 - The system of Clause 1, wherein the model-agnostic integration framework includes a modular plug-in architecture configured to enable substitution of the target LLM with a different one of the plurality of distinct third-party large language models (LLMs) without modifying the configuration settings of the custom AI agent.

Clause 3 - The system of any of Clauses 1-2, wherein the compliance verification engine comprises an ethical AI engine configured to intercept the candidate response and perform a multifaceted evaluation for bias, accuracy, and fairness prior to generating the evaluated response, wherein the multifaceted evaluation is performed independent of an origin of the target LLM.

Clause 4 - The system of any of Clauses 1-3, wherein the instructions further configure the processing circuitry to automatically remediate the candidate response by filtering content that fails the multifaceted evaluation based on the safety protocol.

Clause 5 - The system of any of Clauses 1-4, wherein the multifaceted evaluation includes a hallucination detection check, and wherein generating the evaluated response includes removing portions of the candidate response that fail the hallucination detection check.

Clause 6 - The system of any of Clauses 1-5, wherein the model-agnostic integration framework further includes an agentic framework configured to: autonomously connect to an external enterprise system via a third-party application programming interface (API); and execute a multi-step workflow on the external enterprise system based on the evaluated response without direct user intervention.

Clause 7 - The system of any of Clauses 1-6, wherein the external enterprise system includes at least one of a learning management system (LMS), a customer support ticketing system, or a student information system.

Clause 8 - The system of any of Clauses 1-7, wherein the model-agnostic integration framework includes a vector database layer, and wherein the instructions further configure the processing circuitry to: ingest domain-specific documentation provided via the AI builder interface; convert the domain-specific documentation into vector embeddings stored in the vector database layer; and augment the input query with context retrieved from the vector database layer prior to routing the input query to the target LLM.

Clause 9 - The system of any of Clauses 1-8, wherein the instructions further configure the processing circuitry to: maintain a security agent layer configured to pre-screen the input query for adversarial prompt injection attacks or sensitive data exposure prior to routing the input query to the centralized API layer.

Clause 10 - The system of any of Clauses 1-9, wherein the instructions further configure the processing circuitry to: calculate a transaction-specific metric for the input query, the transaction-specific metric comprising at least one of a privacy impact score, a financial cost, or an environmental carbon footprint score; and display the transaction-specific metric via a user interface associated with the custom AI agent.

Clause 11 - The system of any of Clauses 1-10, wherein the instructions further configure the processing circuitry to orchestrate a multi-agent workflow wherein the custom AI agent coordinates with a second AI agent instantiated on the system to execute a sequential task, and wherein the custom AI agent utilizes the target LLM and the second AI agent utilizes a second, different LLM from the plurality of distinct third-party large language models (LLMs).

Clause 12 - The system of any of Clauses 1-11, wherein the mapping between the task profile and the capability metrics utilizes a model comparison tool configured to benchmark the plurality of distinct third-party large language models (LLMs) against historical performance data regarding latency, cost, and accuracy.

Clause 13 - The system of any of Clauses 1-12, wherein the instructions further configure the processing circuitry to generate a system prompt for the custom AI agent based on a persona defined in the configuration settings, and wherein routing the input query includes transmitting the system prompt to the target LLM.

Clause 14 - The system of any of Clauses 1-13, wherein the instructions further configure the processing circuitry to support a Single Sign-On (SSO) authentication layer that unifies access control across the plurality of distinct third-party large language models (LLMs).

Clause 15 - A method for orchestrating generative artificial intelligence interactions, the method comprising: executing, by processing circuitry, a model-agnostic integration framework to decouple user applications from a plurality of distinct third-party large language models (LLMs); generating, for display on a client device, an AI builder interface; receiving, via the AI builder interface, configuration settings for a custom AI agent, the configuration settings defining a task profile and a safety protocol; instantiating the custom AI agent within the model-agnostic integration framework; receiving an input query directed to the custom AI agent; selecting a target LLM from the plurality of distinct third-party large language models (LLMs) based on a mapping between the task profile and capability metrics associated with the target LLM; routing the input query to the target LLM via a centralized API layer; receiving a candidate response from the target LLM; executing, by the processing circuitry, a compliance verification engine; evaluating, using the compliance verification engine, the candidate response against the safety protocol defined in the configuration settings to generate an evaluated response; and outputting the evaluated response.

Clause 16 - The method of Clause 15, wherein the compliance verification engine comprises an ethical AI engine, and wherein the method further comprises: intercepting the candidate response to perform a multifaceted evaluation for bias, accuracy, and fairness prior to generating the evaluated response, wherein the multifaceted evaluation is performed independent of an origin of the target LLM.

Clause 17 - The method of any of Clauses 15-16, further comprising: autonomously connecting to an external enterprise system via a third-party application programming interface (API) using an agentic framework; and executing a multi-step workflow on the external enterprise system based on the evaluated response without direct user intervention.

Clause 18 - The method of any of Clauses 15-17, further comprising: ingesting domain-specific documentation provided via the AI builder interface; converting the domain-specific documentation into vector embeddings stored in a vector database layer; and augmenting the input query with context retrieved from the vector database layer prior to routing the input query to the target LLM.

Clause 19 - The method of any of Clauses 15-18, further comprising: calculating a transaction-specific metric for the input query, the transaction-specific metric comprising at least one of a privacy impact score, a financial cost, or an environmental carbon footprint score; and displaying the transaction-specific metric via a user interface associated with the custom AI agent.

Clause 20 - A non-transitory computer-readable medium storing instructions that, when executed by processing circuitry, cause the processing circuitry to: execute a model-agnostic integration framework to decouple user applications from a plurality of distinct third-party large language models (LLMs); generate, for display on a client device, an AI builder interface; receive, via the AI builder interface, configuration settings for a custom AI agent, the configuration settings defining a task profile and a safety protocol; instantiate the custom AI agent within the model-agnostic integration framework; receive an input query directed to the custom AI agent; select a target LLM from the plurality of distinct third-party large language models (LLMs) based on a mapping between the task profile and capability metrics associated with the target LLM; route the input query to the target LLM via a centralized API layer; receive a candidate response from the target LLM; execute a compliance verification engine; evaluate, using the compliance verification engine, the candidate response against the safety protocol defined in the configuration settings and generate an evaluated response; and output the evaluated response.

Clause 21 - A computer program product comprising one or more instructions that, when executed by at least one processor, cause the at least one processor to perform any of the methods of clauses 15-19.

Clause 22 - A device comprising means for performing any of the methods of clauses 15-19.

Depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, read-only memory (ROM), electrically erasable programmable read-only memory (EEPROM), compact disc read-only memory (CD-ROM) or other optical disk storage, magnetic disk storage, or other magnetic storage devices, flash memory, or any other medium that may be used to store desired program code in the form of instructions or data structures and that may be accessed by a computer. Also, any connection is termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, field-programmable gate arrays (FPGAs), or other integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system for orchestrating generative artificial intelligence interactions, the system comprising:
processing circuitry; and
non-transitory computer-readable media comprising instructions that, when executed by the processing circuitry, configure the processing circuitry to:
execute a model-agnostic integration framework to decouple user applications from a plurality of distinct third-party large language models (LLMs);
generate, for display on a client device, an AI builder interface;
receive, via the AI builder interface, configuration settings for a custom AI agent, the configuration settings defining a task profile and a safety protocol;
instantiate the custom AI agent within the model-agnostic integration framework;
receive an input query directed to the custom AI agent;
select a target LLM from the plurality of distinct third-party LLMs based on a mapping between the task profile and capability metrics associated with the target LLM;
route the input query to the target LLM via a centralized API layer;
receive a candidate response from the target LLM;
execute a compliance verification engine;
evaluate, using the compliance verification engine, the candidate response against the safety protocol defined in the configuration settings and generate an evaluated response; and
output the evaluated response.

2. The system of claim 1, wherein the model-agnostic integration framework includes a modular plug-in architecture configured to enable substitution of the target LLM with a different one of the plurality of distinct third-party LLMs without modifying the configuration settings of the custom AI agent.

3. The system of claim 1, wherein the compliance verification engine comprises an ethical AI engine configured to intercept the candidate response and perform a multifaceted evaluation for bias, accuracy, and fairness prior to generating the evaluated response, wherein the multifaceted evaluation is performed independent of an origin of the target LLM.

4. The system of claim 3, wherein the instructions further configure the processing circuitry to automatically remediate the candidate response by filtering content that fails the multifaceted evaluation based on the safety protocol.

5. The system of claim 3, wherein the multifaceted evaluation includes a hallucination detection check, and wherein generating the evaluated response includes removing portions of the candidate response that fail the hallucination detection check.

6. The system of claim 1, wherein the model-agnostic integration framework further includes an agentic framework configured to:
autonomously connect to an external enterprise system via a third-party application programming interface (API); and
execute a multi-step workflow on the external enterprise system based on the evaluated response without direct user intervention.

7. The system of claim 6, wherein the external enterprise system includes at least one of a learning management system (LMS), a customer support ticketing system, or a student information system.

8. The system of claim 1, wherein the model-agnostic integration framework includes a vector database layer, and wherein the instructions further configure the processing circuitry to:
ingest domain-specific documentation provided via the AI builder interface;
convert the domain-specific documentation into vector embeddings stored in the vector database layer; and
augment the input query with context retrieved from the vector database layer prior to routing the input query to the target LLM.

9. The system of claim 1, wherein the instructions further configure the processing circuitry to:
maintain a security agent layer configured to pre-screen the input query for adversarial prompt injection attacks or sensitive data exposure prior to routing the input query to the centralized API layer.

10. The system of claim 1, wherein the instructions further configure the processing circuitry to:
calculate a transaction-specific metric for the input query, the transaction-specific metric comprising at least one of a privacy impact score, a financial cost, or an environmental carbon footprint score; and
display the transaction-specific metric via a user interface associated with the custom AI agent.

11. The system of claim 1, wherein the instructions further configure the processing circuitry to orchestrate a multi-agent workflow wherein the custom AI agent coordinates with a second AI agent instantiated on the system to execute a sequential task, and wherein the custom AI agent utilizes the target LLM and the second AI agent utilizes a second, different LLM from the plurality of distinct third-party LLMs.

12. The system of claim 1, wherein the mapping between the task profile and the capability metrics utilizes a model comparison tool configured to benchmark the plurality of distinct third-party LLMs against historical performance data regarding latency, cost, and accuracy.

13. The system of claim 1, wherein the instructions further configure the processing circuitry to generate a system prompt for the custom AI agent based on a persona defined in the configuration settings, and wherein routing the input query includes transmitting the system prompt to the target LLM.

14. The system of claim 1, wherein the instructions further configure the processing circuitry to support a Single Sign-On (SSO) authentication layer that unifies access control across the plurality of distinct third-party LLMs.

15. A method for orchestrating generative artificial intelligence interactions, the method comprising:
executing, by processing circuitry, a model-agnostic integration framework to decouple user applications from a plurality of distinct third-party large language models (LLMs);
generating, for display on a client device, an AI builder interface;
receiving, via the AI builder interface, configuration settings for a custom AI agent, the configuration settings defining a task profile and a safety protocol;
instantiating the custom AI agent within the model-agnostic integration framework;
receiving an input query directed to the custom AI agent;
selecting a target LLM from the plurality of distinct third-party LLMs based on a mapping between the task profile and capability metrics associated with the target LLM;
routing the input query to the target LLM via a centralized API layer;
receiving a candidate response from the target LLM;
executing, by the processing circuitry, a compliance verification engine;
evaluating, using the compliance verification engine, the candidate response against the safety protocol defined in the configuration settings to generate an evaluated response; and
outputting the evaluated response.

16. The method of claim 15, wherein the compliance verification engine comprises an ethical AI engine, and wherein the method further comprises:
intercepting the candidate response to perform a multifaceted evaluation for bias, accuracy, and fairness prior to generating the evaluated response, wherein the multifaceted evaluation is performed independent of an origin of the target LLM.

17. The method of claim 15, further comprising:
autonomously connecting to an external enterprise system via a third-party application programming interface (API) using an agentic framework; and
executing a multi-step workflow on the external enterprise system based on the evaluated response without direct user intervention.

18. The method of claim 15, further comprising:
ingesting domain-specific documentation provided via the AI builder interface;
converting the domain-specific documentation into vector embeddings stored in a vector database layer; and
augmenting the input query with context retrieved from the vector database layer prior to routing the input query to the target LLM.

19. The method of claim 15, further comprising:
calculating a transaction-specific metric for the input query, the transaction-specific metric comprising at least one of a privacy impact score, a financial cost, or an environmental carbon footprint score; and
displaying the transaction-specific metric via a user interface associated with the custom AI agent.

20. A non-transitory computer-readable medium storing instructions that, when executed by processing circuitry, cause the processing circuitry to:
execute a model-agnostic integration framework to decouple user applications from a plurality of distinct third-party large language models (LLMs);
generate, for display on a client device, an AI builder interface;
receive, via the AI builder interface, configuration settings for a custom AI agent, the configuration settings defining a task profile and a safety protocol;
instantiate the custom AI agent within the model-agnostic integration framework;
receive an input query directed to the custom AI agent;
select a target LLM from the plurality of distinct third-party LLMs based on a mapping between the task profile and capability metrics associated with the target LLM;
route the input query to the target LLM via a centralized API layer;
receive a candidate response from the target LLM;
execute a compliance verification engine;
evaluate, using the compliance verification engine, the candidate response against the safety protocol defined in the configuration settings and generate an evaluated response; and
output the evaluated response.
